(19) United States
(12) Patent Application Publication
(10) Pub. No.: US 2009/0234662 A1
(43) Pub. Date: Sep. 17, 2009

(54) Unified Enterprise Contract Management Architecture

(75) Inventors: Rhonda Stieber, Los Altos, CA (US); Vijayanand Rajkumar, Redwood City, CA (US)

Correspondence Address: AKA CHAN LLP / ORACLE, 900 LAFAYETTE STREET, SUITE 710, SANTA CLARA, CA, 95050, US

(73) Assignee: Oracle International Corporation, Redwood Shores, CA (US)

(21) Appl. No.: 12/047,549

(22) Filed: Mar. 13, 2008

(51) Int. Cl. G06Q 10/00

(52) U.S. Cl. 705/1

(57) ABSTRACT

An enterprise contract management system allows users to define different types of contracts that will support different types of lines. A common contract management infrastructure supports basic contracting capabilities common to a number of types of contracts (or every contract type handled by the system). These capabilities include defining basic attributes about a contract like number and description, defining contract parties, contract printing, versioning, status management, change control, and security. These common capabilities will be available for any type of contract handled by the system. When a user defines a contract of a particular type, the system allows the user to add lines to a contract that represent different types of agreements with a customer. Lines can describe a sale of goods, a sale of an extended warranty or support, a sale of simple service, a sale of complex service, a long-term sales agreement, a lease or rental, or any other type of customer agreement.

### BACKGROUND OF THE INVENTION

This invention relates to the field of enterprise contract management and more specifically, to a unified technique and system for managing and tracking such contracts.

Organizations and companies, especially large organizations, enter into numerous contracts and relationships with other entities. Generally, the contracts will be different from each other. The contracts will have different terms because they are for different subject matter, relate to different types of relationships, a group in an organization may draft a contract slightly differently from other groups, and for numerous other reasons.

A particular type of contract where there are numerous different types is the sales contract. The different types of sales contracts include, but are not limited to: (1) sale of goods, such as selling of computers, routers, software, other products, (2) sale of an extended warranty or support, such as a two-year extended warranty on a computer or support on software, (3) sale of simple service, such as subscription service or installation service, (4) sale of complex service, such as a contract to deliver a project to construct a bridge, (5) long-term sales agreement, which could specify that a customer has a discount of 10 percent for a particular product, or if the customer agrees to purchase 10,000 computers over the course of a year in return for a 20 percent discount, and (6) lease or rental, such as lease of a photocopier, scanner, or other equipment.

Because there are differences between the various types of contracts (especially in terms of how they are fulfilled), it makes it more difficult to manage the contracts within the organization. Existing contract applications cannot support all these different types of arrangements on a single contract or the execution needed to fulfill various types of contractual arrangements. In order to manage the contracts in current contract applications, organizations frequently must use multiple computer applications to support different types of contracts. This in turn forces the organizations to adjust their business processes to sign separate contracts with their customers rather than streamlining the process to use a single contract.

For example, a networking company might do a deal to sell routers, extended warranty on the routers, and a project to design the customer's network. The contract might also include a provision for a 10 percent discount on future purchases of routers for the next year. These four different facets of the sale have different contract management and execution requirements. The company must be able to ship the routers, handle service calls for the routers based on the terms of the extended warranty, and track a project, manage the work, and handle time and materials billing for the network design. The company must also honor the 10 percent discount for future purchases. The contract must include all the information to support all these execution activities.

The networking company would like to be able to negotiate a single contract with the customer, and track all the different aspects of the deal in a single contract management system. However, each facet of the contract requires different types of attributes that must be tracked, and integration to different execution systems (e.g., shipping, customer care, and project accounting).

Current contract application software cannot handle managing all these different types of arrangements in a single contract. Contract applications typically provide support for one aspect of this type of sale. Because of limitations in their application software, the networking company could be forced to negotiate two or more separate contracts with the customer—for example, one contract for the router, extended warranty, and future discount, and a separate contract for the network design project. Or the company may negotiate a contract off-line manually with all these elements and then input the relevant information into multiple systems to fulfill the contract.

This makes the sales and contract fulfillment process more complex because it requires multiple contracts. The sales cycle requires more effort which can cause lost business and reduced revenues. Contract management and execution also become more difficult because users cannot look at the entire deal in one place since it is stored in multiple contracts systems. This adds complexity in reporting and determining overall profitability of the deal, as well as issues in recognizing revenue accurately.

As can be appreciated, it is desirable for an organization to be able to effectively and efficiently manage contracts, especially different contract types and contracts with multiple types of arrangements. Therefore, there is a need for a unified technique and system for managing and tracking enterprise contracts.

### BRIEF SUMMARY OF THE INVENTION

An enterprise contract management system allows users to define different types of contracts that will support different types of lines (that correspond to the different types of things that are sold via the contract). A common contract management infrastructure supports basic contracting capabilities common to a number of types of contracts (or every contract type handled by the system). These capabilities include defining basic attributes about a contract like number and description, defining contract parties, contract printing, versioning, change control, and security. These common capabilities will be available for any type of contract handled by the system. When a user defines a contract of a particular type, the system allows the user to add lines to a contract that represent the different types of things that are sold to the customer.

The invention allows companies to negotiate contracts in the way that best suits their business needs. Companies can track all aspects of a contract in the application, and support different types of execution such as shipping, delivering service, or billing. This invention allows companies to configure the contract application to support all the types of sales deals that the company engages in (and only the types of sales deals that the company engages in). This way, a company can include all aspects of a deal in a single contract so that deals can be finalized as quickly as possible. This drives more sales and increased revenue. It also simplifies contract management and reporting.

In an implementation, the invention is a method including: for interfacing to an enterprise contract management system, displaying a first computer user interface screen for a user to specify a contract type for a contract, where the enterprise contract management system handles different contract types; and after the user specifies the contract type, displaying a second computer user interface screen for the user to specify common contract information including contract parties, terms and conditions, and one or more contract lines. Each contract line is for a particular type of line, from the number of different contract line types for the contract defined prior in the system (a contract line type corresponds to a particular type of item that is sold).

An aspect of the invention is that each contract type is setup prior to specify the allowed line types for that type of contract. This drives the subsequent user interface on what line specific attributes are shown and executed upon when the contract is authored.

In an implementation, the invention is a method including: displaying an interface screen for defining the common attributes for a contract handled by the enterprise contract management system; and displaying an interface screen for adding of contract lines for each contract, where each contract line comprises a separate set of attributes of the contract trackable by the enterprise contract management system.

In an implementation, the invention is a system including: an enterprise contract management application component, where each contract may be specified using multiple contract lines, each contract line including a separate set of attributes of a contract trackable by the enterprise contract management system; a database component, interfacing with the enterprise contract management application and storing contract data of the enterprise contract management application; and a user interface component, interfacing with the enterprise contract management application and permitting a user to create a contract in the enterprise contract management system.

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1 shows a block diagram of a client-server system and network in which an embodiment of the invention may be implemented.

FIG. 2 shows a more detailed diagram of an exemplary client or computer which may be used in an implementation of the invention.

FIG. 3 shows a system block diagram of a client computer system used to provide a user interface according to the invention.

FIG. 4 shows data source or data service in the form of a database system.

FIG. 5 shows an overview of an enterprise contract management system utilizing different contracts forms (or applications) for each contract type.

FIG. 6 shows a block diagram of an electronic contract management system that handles multiple contract types.

FIG. 7 shows a computer user interface screen for authoring a contract.

FIG. 8 shows a computer screen for a contracts types definition page of a unified electronic contract management system.

FIG. 9 shows a computer user interface screen for specifying contract line types.

FIG. 10 shows another example of a computer user interface screen for specifying contract line types.

FIG. 11 shows a computer screen with a sales agreement line for a price hold.

FIG. 12 shows a computer screen for a contract authorizing, service line, page of a unified electronic contract management system.

### DETAILED DESCRIPTION OF THE INVENTION

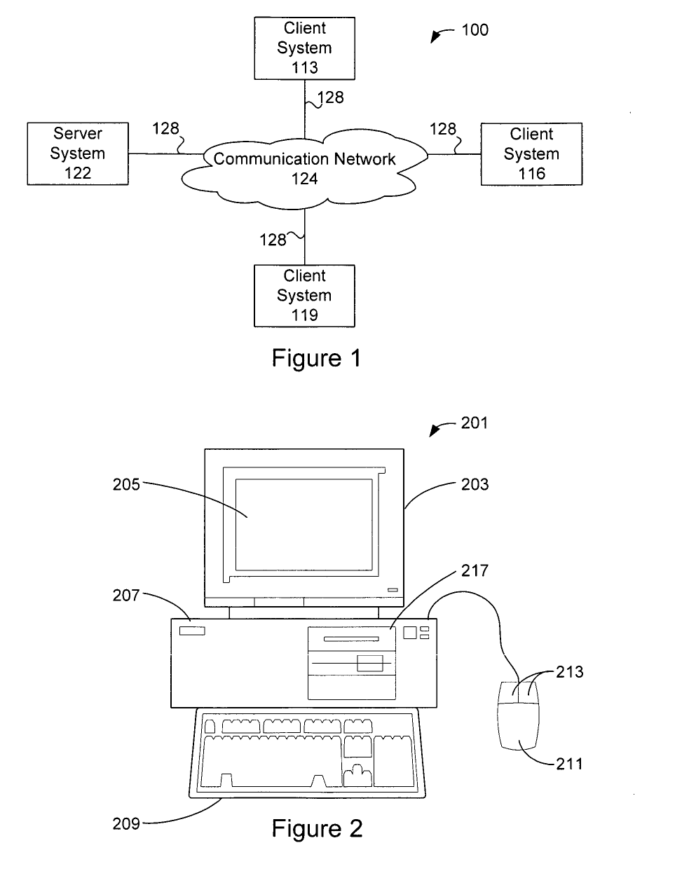

FIG. 1 is a simplified block diagram of a distributed computer network 100 which may include an implementation of the present invention. Computer network 100 includes a number of client systems 113, 116, and 119, and a server system 122 coupled to a communication network 124 via a plurality of communication links 128. There may be any number of clients and servers in a system. Communication network 124 provides a mechanism for allowing the various components of distributed network 100 to communicate and exchange information with each other.

Communication network 124 may itself be comprised of many interconnected computer systems and communication links. Communication links 128 may be hardwire links, optical links, satellite or other wireless communications links, wave propagation links, or any other mechanisms for communication of information. Various communication protocols may be used to facilitate communication between the various systems shown in FIG. 1. These communication protocols may include TCP/IP, HTTP protocols, wireless application protocol (WAP), vendor-specific protocols, customized protocols, and others. While in one embodiment, communication network 124 is the Internet, in other embodiments, communication network 124 may be any suitable communication network including a local area network (LAN), a wide area network (WAN), a wireless network, a intranet, a private network, a public network, a switched network, and combinations of these, and the like.

Distributed computer network 100 in FIG. 1 is merely illustrative of an embodiment incorporating the present invention and does not limit the scope of the invention as recited in the claims. One of ordinary skill in the art would recognize other variations, modifications, and alternatives. For example, more than one server system 122 may be connected to communication network 124. As another example, a number of client systems 113, 116, and 119 may be coupled to communication network 124 via an access provider (not shown) or via some other server system.

Client systems 113, 116, and 119 typically request information from a server system which provides the information. For this reason, server systems typically have more computing and storage capacity than client systems. However, a particular computer system may act as both as a client or a server depending on whether the computer system is requesting or providing information. Additionally, although aspects of the invention has been described using a client-server environment, it should be apparent that the invention may also be embodied in a stand-alone computer system.

Server 122 is responsible for receiving information requests from client systems 113, 116, and 119, performing processing required to satisfy the requests, and for forwarding the results corresponding to the requests back to the requesting client system. The processing required to satisfy the request may be performed by server system 122 or may alternatively be delegated to other servers connected to communication network 124.

According to the teachings of the present invention, client systems 113, 116, and 119 enable users to access and query information stored by server system 122. In a specific embodiment, a “Web browser” application executing on a client system enables users to select, access, retrieve, or query information stored by server system 122. Examples of web browsers include the Internet Explorer browser program provided by Microsoft Corporation, and the Firefox browser provided by Mozilla Foundation, and others.

FIG. 2 shows an exemplary client or server system of the present invention. In an embodiment, a user interfaces with the system through a computer workstation system, such as shown in FIG. 2. FIG. 2 shows a computer system 201 that includes a monitor 203, screen 205, cabinet 207, keyboard 209, and mouse 211. Mouse 211 may have one or more buttons such as mouse buttons 213. Cabinet 207 houses familiar computer components, some of which are not shown, such as a processor, memory, mass storage devices 217, and the like.

Mass storage devices 217 may include mass disk drives, floppy disks, magnetic disks, optical disks, magneto-optical disks, fixed disks, hard disks, CD-ROMs, recordable CDs, DVDs, recordable DVDs (e.g., DVD-R, DVD+R, DVD-RW, DVD+RW, HD-DVD, or Blu-ray Disc), flash and other nonvolatile solid-state storage (e.g., USB flash drive), battery-backed-up volatile memory, tape storage, reader, and other similar media, and combinations of these.

A computer-implemented or computer-executable version of the invention may be embodied using, stored on, or associated with computer-readable medium. A computer-readable medium may include any medium that participates in providing instructions to one or more processors for execution. Such a medium may take many forms including, but not limited to, nonvolatile, volatile, and transmission media. Nonvolatile media includes, for example, flash memory, or optical or magnetic disks. Volatile media includes static or dynamic memory, such as cache memory or RAM. Transmission media includes coaxial cables, copper wire, fiber optic lines, and wires arranged in a bus. Transmission media can also take the form of electromagnetic, radio frequency, acoustic, or light waves, such as those generated during radio wave and infrared data communications.

For example, a binary, machine-executable version, of the software of the present invention may be stored or reside in RAM or cache memory, or on mass storage device 217. The source code of the software of the present invention may also be stored or reside on mass storage device 217 (e.g., hard disk, magnetic disk, tape, or CD-ROM). As a further example, code of the invention may be transmitted via wires, radio waves, or through a network such as the Internet.

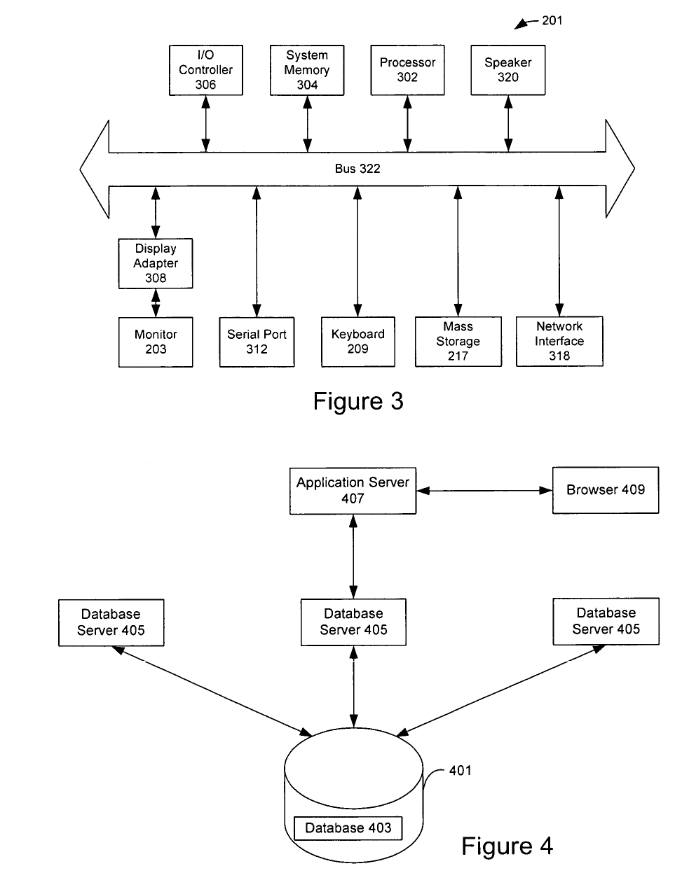

FIG. 3 shows a system block diagram of computer system 201 which may be used to execute software of the present invention. As in FIG. 2, computer system 201 includes monitor 203, keyboard 209, and mass storage devices 217. Computer system 201 further includes subsystems such as central processor 302, system memory 304, input/output (I/O) controller 306, display adapter 308, serial or universal serial bus (USB) port 312, network interface 318, and speaker 320. The invention may also be used with computer systems with additional or fewer subsystems. For example, a computer system could include more than one processor 302 (i.e., a multiprocessor system) or a system may include a cache memory.

Arrows such as 322 represent the system bus architecture of computer system 201. However, these arrows are illustrative of any interconnection scheme serving to link the subsystems. For example, speaker 320 could be connected to the other subsystems through a port or have an internal direct connection to central processor 302. The processor may include multiple processors or a multicore processor, which may permit parallel processing of information. Computer system 201 shown in FIG. 2 is but an example of a computer system suitable for use with the present invention. Other configurations of subsystems suitable for use with the present invention will be readily apparent to one of ordinary skill in the art.

Computer software products may be written in any of various suitable programming languages, such as C, C++, C#, Pascal, Fortran, Perl, Matlab (from MathWorks), SAS, SPSS, JavaScript, AJAX, and Java. The computer software product may be an independent application with data input and data display modules. Alternatively, the computer software products may be classes that may be instantiated as distributed objects. The computer software products may also be component software such as Java Beans (from Sun Microsystems) or Enterprise Java Beans (EJB from Sun Microsystems).

An operating system for the system may be one of the Microsoft Windows® family of operating systems (e.g., Windows 95, 98, Me, Windows NT, Windows 2000, Windows XP, Windows XP x64 Edition, Windows Vista, Windows CE, Windows Mobile), Linux, HP-UX, UNIX, Sun OS, Solaris, Mac OS X, Alpha OS, AIX, IRIX32, or IRIX64. Other operating systems may be used. Microsoft Windows is a trademark of Microsoft Corporation.

Furthermore, the computer may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, and 802.11n, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

FIG. 4 shows a data source or data service in the form of a database system. A database may be part of a database management system. One suitable database management system architecture is a three-tiered architecture as shown.

In a first tier is the core of a database management system, a central storage 401 that holds or stores a database or repository 403. The database typically resides on one or more hard drives, and is generally part of a larger computer system. The information may be stored in the database in a variety of formats. An example is a relational database management system (RDMS) which uses tables to store the information.

In a second tier are database servers 405. The database servers are instances of a program that interacts with the database. Each instance of a database server may, among other features, independently query the database and store information in the database. Depending on the implementation, the database servers 405 may or may not include user-friendly interfaces, such as graphical user interfaces.

In a third tier is an application server 407. There may be multiple application servers. In an implementation, the application server provides the user interfaces to the database servers. By way of example, the application server may be a web application server on the Internet or any other network. The application server may also be a virtual database server or a virtual directory server. The application server may provide user-friendly mechanisms and interfaces for accessing the database through the database servers. In an implementation, a web browser 409 is utilized to access the application server.

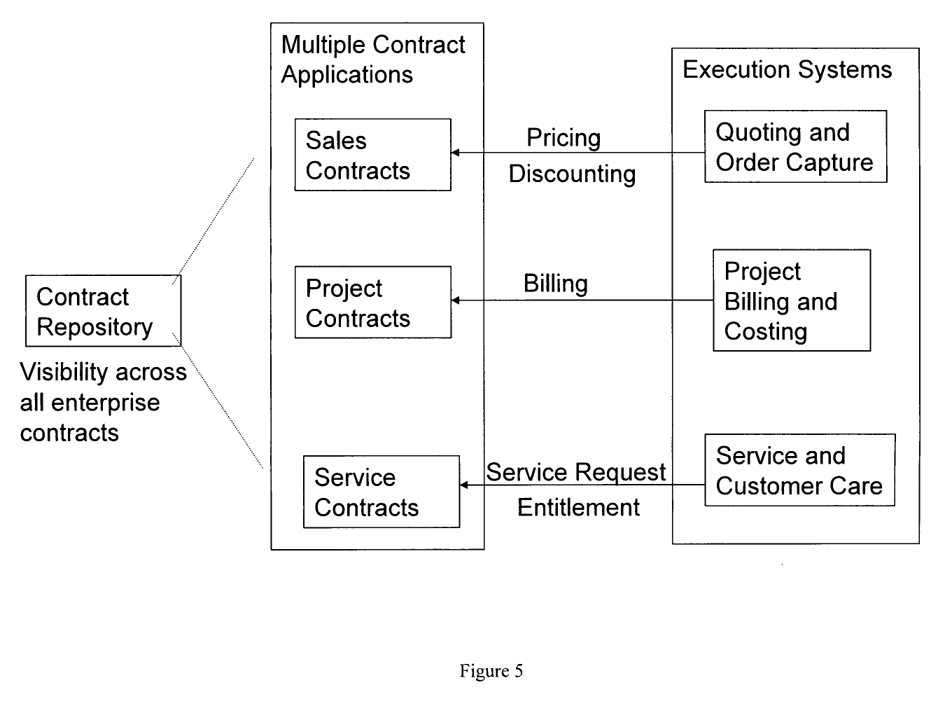

FIG. 5 shows an overview of an enterprise contract management system utilizing a different contract form or application, or both, for each contract type. In this figure, there are sales contracts, project contracts, and each type of contract is related to various parameters as shown. The different contracts types are electronically archived in a contract repository.

For each contractual arrangement, there is a separate contract application (e.g., sales contract application, project contract application, and service contract application). Furthermore, a single contract application does not support all of the execution needed to fulfill various such arrangements.

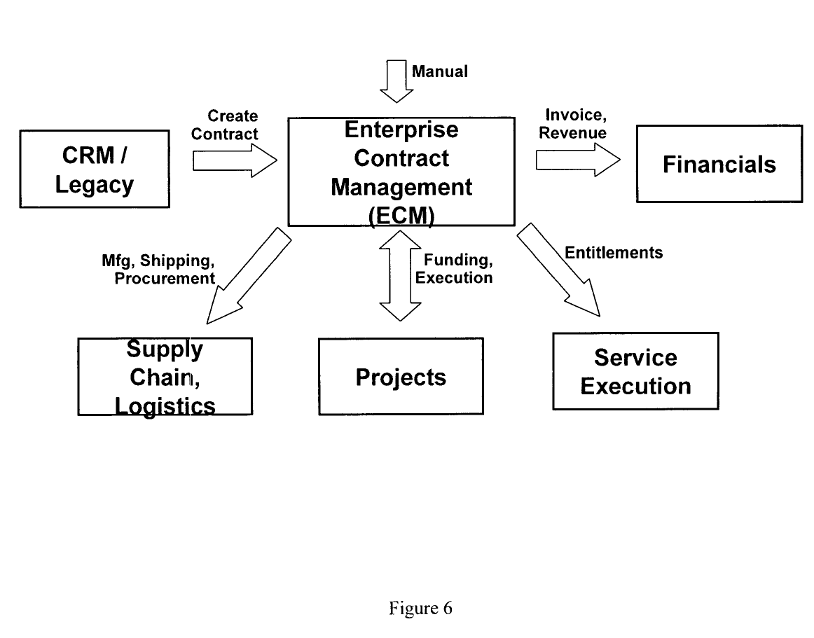

FIG. 6 shows a block diagram of an electronic contract management system that handles multiple contract types. This system may be referred to as a unified electronic contract management system. The system has an enterprise contract management (ECM) component that handles various different types of contracts. Data for each contract managed by the system may be stored in a database.

This system can manage contracts for goods, services and complex work (projects) in any combination. The system handles execution for all the types of contracts by integrating to execution systems for fulfillment and billing. The system can manage billing and revenue for complex work including bill by contact, fulfillment of goods and services, and reporting including providing visibility for many or all aspects of a particular deal. A unified electronic contract management system may handle any number of contract types, more, less, some, or different from the specific examples described in this application.

In a specific implementation, the enterprise contract management system allows users to define different types of contracts that will support different types of lines. A common contract management infrastructure supports basic contracting capabilities common to a number of types of contracts (or every contract type handled by the system). These capabilities include defining basic attributes about a contract like number and description, defining contract parties, contract printing, versioning, change control, and security. These common capabilities will be available for any type of contract handled by the system. When a user defines a contract of a particular type, the system allows the user to add lines to a contract that represent different types of agreements with a customer.

The system may include any one or more of the following features in any combination: authoring framework; basic attributes, parties or accounts, notes, attachments; dashboard or home page (for contract users); process analytics; status management; change management, amendments, versioning; terms and conditions authoring; contract policy compliance and deviations reporting; approvals; printing, on-line signatures; document management and text search; desktop integration (e.g., integrated with Microsoft Office, Microsoft Word); Word export and synchronization; renewal management; audit; and collaboration (e.g., internal reviews, e-mail, on-line negotiation).

A system of the invention supports execution of various contract types. One can define a contract type as an attribute of a contract. Moreover, the user interface changes based on the contract type: the system captures attributes specific to the contract type and hides others that are not relevant. Also, the system ensures the transactions are compliant with what was negotiated in the contract.

For example, in a time and material based contract, the system not only captures spending limits in the contract (e.g., how much you can spend for travel expenses), but also ensures when someone reports expenses they do not exceed any applicable limits defined in the contract for that type of expense. That is the execution part. Also, based on the contract type (i.e., time and material), the system shows the attributes to capture spending limits and do not show it on other contract types for which it is not applicable.

A specific flow for operating an electronic contract management system is presented below, but it should be understood that the invention is not limited to the specific flows and steps presented. A flow of the invention may have additional steps (not necessarily described in this application), different steps which replace some of the steps presented, fewer steps or a subset of the steps presented, or steps in a different order than presented, or any combination of these. Further, the steps in other implementations of the invention may not be exactly the same as the steps presented and may be modified or altered as appropriate for a particular application or based on the data.

1. Specify Contract Type. When using a system of the invention, when creating a new contract, the user specifies a contract type. The contract type specifies intent (e.g., buy or sell) and contract line types (see below) that will be sold or purchased.

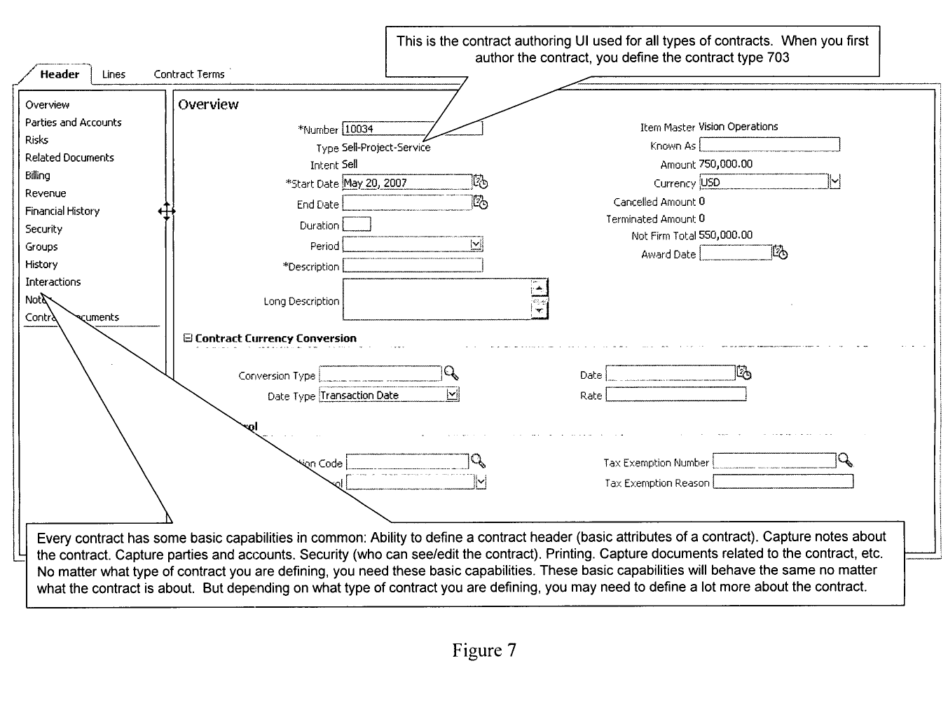

FIG. 7 shows an example of a computer user interface screen for authoring a contract. Through this screen, a user specifies a contract type 703. The contract type drives the overall user interface: A user will see only information, text boxes, and entry components relevant for that type of items they are selling or procuring. For example, if the user specifies the contract type is a sales contract for goods only, then subsequent screens will show only items relevant to a this type of sales contract.

In an implementation, the contract type is user definable. For example, a system administrator or other user can set up the contract types the system will accept. Some examples of contract types include a pricing agreement, fixed price consulting agreement, service contract, cost-plus research agreement, and equipment lease agreement.

In the user interface screen in FIG. 7, in an overview section of a header tab of the screen, there are text boxes for number, start date, end date, duration, period, description, long description, known as, currency, and award date. In a contract currency conversion section of the screen, there is a conversion type drop down list, date type, date, and rate.

Further, there is a left hand menu bar of the header tab. This menu provides the basic capabilities for the contracts handled by the system, regardless of what contact is being defined. These basic capabilities will behave the same, regardless of the contract. The menu also includes certain information that is specific to the type of contract being authored. The options in the header menu will change depending on the contract type that was chosen.

As an example, in this figure, the items pertinent to contracts handled by this system and the type of contract currently being created including overview, parties and accounts, risks, related documents, billing, revenue, financial history, security, groups, history, interactions, notes, and contract documents. The user has the ability to define a contract header, where are basic attributes of a contract, capture notes about the contract, capture parties and accounts, security (i.e., who can see or edit the contract), printing, and capture documents related to the contract. In other embodiments of the invention, further options may be available.

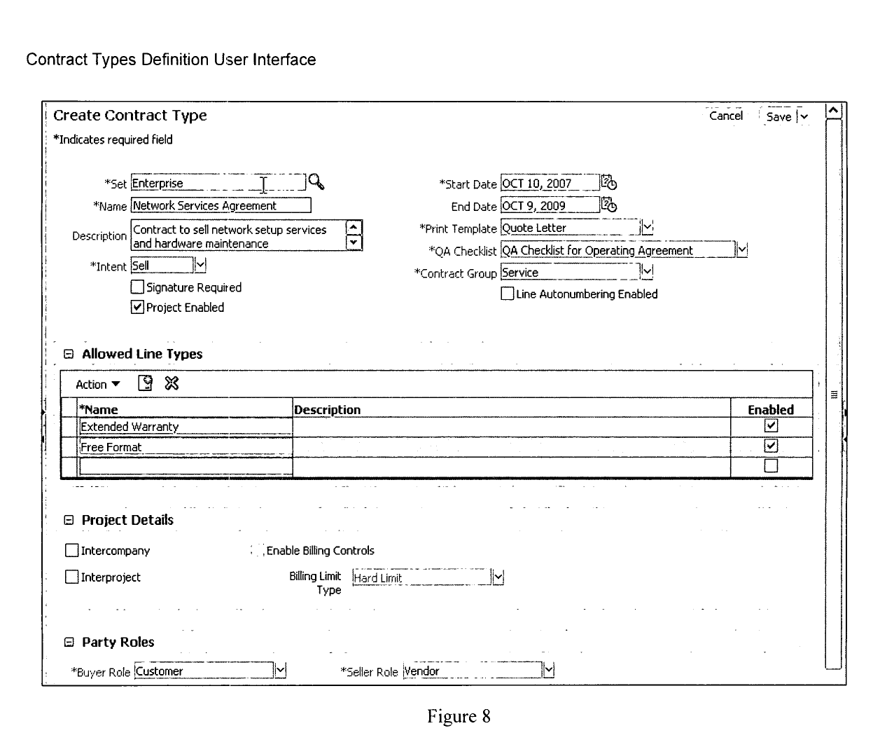

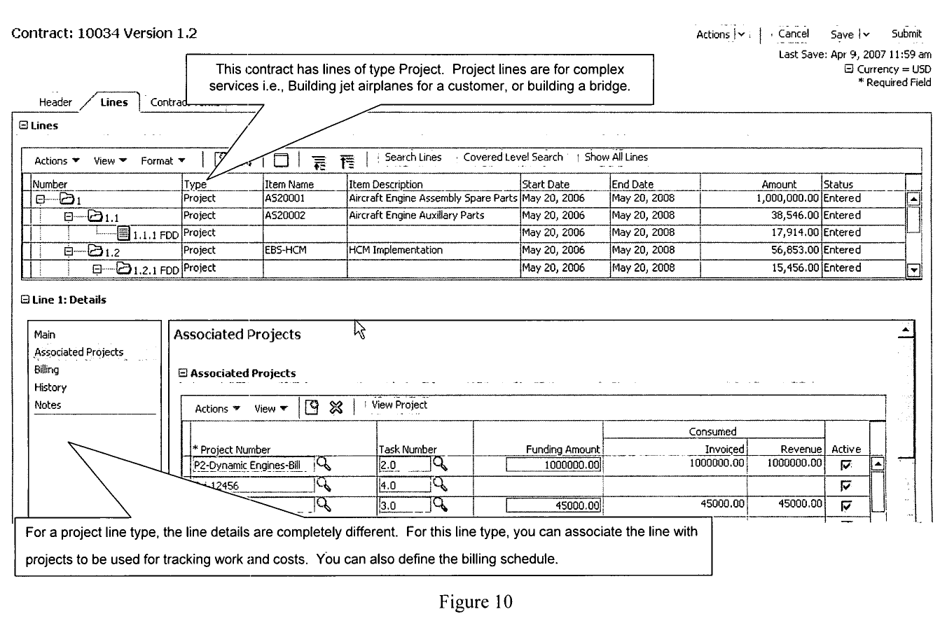

FIG. 8 shows another computer screen for a contracts type definition page of a unified electronic contract management system. This allows a user or system administrator to define the contract types that can be selected when defining a contract. In the “Allowed Line Types” region in FIG. 10, the user can specify what line types are allowed for this contract type. This will restrict what line types the user can create when creating a contract of this type.

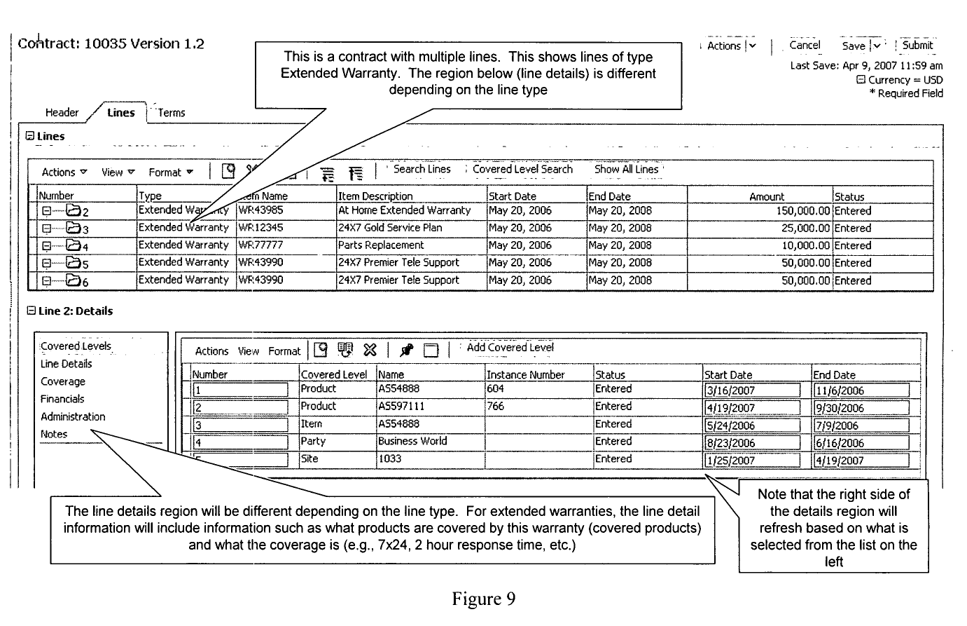

2. Referring to FIG. 9, specify Contract Line Type. After specifying the contract type, the user specifies one or more contract line types for the contract being authored. The contract line type specifies the type of item that is being sold or the subject matter of the contract. There are various contract lines types. Some examples of item types include a project-based item, extended warranty, goods, price-hold, subscription, usage, lease, and intellectual property.

A contract may have any number of contract line types, depending on what is allowed for that contract type. For example, one contract may have one, two, three, four, five, six, or more contract line types. The line type determines the information captured for the line and the subsequent downstream execution. In a specific implementation, the contract line type is system defined, and not user defined.

FIG. 9 shows a computer user interface screen for specifying contract lines. Through this screen, the user can add, remove, modify, and view the contract lines. The user must specify a contract line type for each line. This screen is accessible through a lines tab of the interface. Using this interface, the user can add, for example, a line for an extended warranty that allows the user to define what type of coverage the company is providing (e.g., 7×24 gold support), how the company will be charging for the extended warranty (e.g., $100 per month) and what products are covered under the extended warranty (e.g., laptops).

The screen in FIG. 9 shows a contract with multiple lines for extended warranties For example, line number 2 is an extended warranty for an item name WR43985. The details for a selected line are shown below in a line details portion of the window. In this sample screen, the line 2 details are shown. The line details will be different depending on the line type. For extended warranties, the line detail information will include information such as what products are covered by this warranty (covered products) and what the coverage is (e.g., 7×24, 2-hour response time, and so forth). The right side of the details region will refresh based on what is selected from the list on the left.

FIG. 10 shows another example of a computer user interface screen for specifying contract lines. In this sample screen, the contract has multiple lines of type project. Project lines are typically for complex services such as building jet airplanes for a customer or building a bridge. The project type of line allows the user to define attributes that are important for this situation such as the project used to track the work and costs, billing schedule, delivery schedule, and price (either fixed price, T&M, or other type of pricing).

In the details portion of the window, for a project line type, the line details are completely different from other line types. For the projects line type, a user can associate the line with projects to be used for tracking work and cost. The user can also define a billing schedule.

The user can also add a contract line to a contract to define agreements for future purchases (e.g., price discounts or tiered pricing). In this case, the user might define that a customer gets a 10 percent discount for all laptop computer purchases going forward (either specific products, or product categories). Or the user can define that a customer has committed to purchasing 1000 laptops, and therefore gets a 15 percent discount.

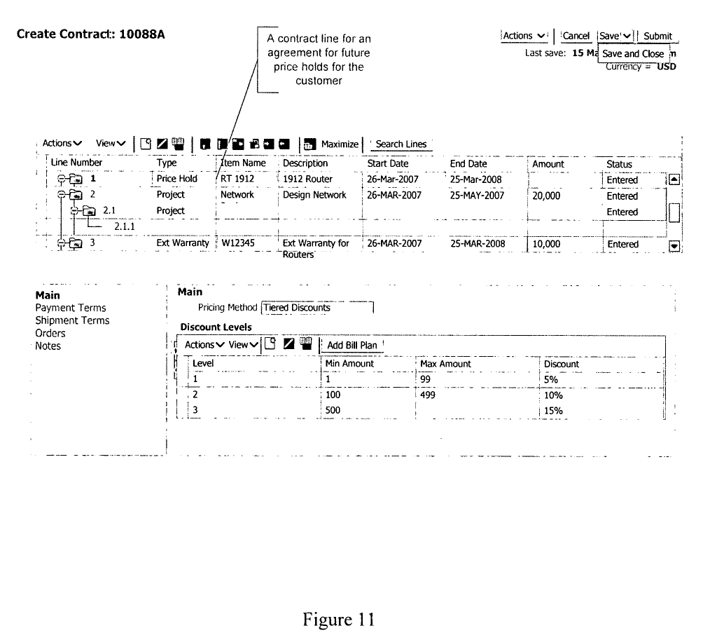

FIG. 11 shows a computer screen with a sales agreement line for a price hold. A price hold line type allows holding of a price for an item for a certain period of time, which is specified using start date and end date. For example, a buyer wants to pay a seller to ensure the buyer can buy routers at a guaranteed price for a period of time. The price hold line type allows specifying of this type of contractual term.

Also, in this computer screen, there are multiple line types specified in a single contract. There is a price hold type, project type, and extended warranty type specified in the same contract. Any of the lines types discussed in this patent, or other lines types not discussed, or both, may be associated with other line types in any combination as appropriate. For example, project type may be combined with extended warranty type. The project type may be combined with the price hold type. The price hold type may be combined with the extended warranty type. Two, three, four, or more number of types may be in the same contract.

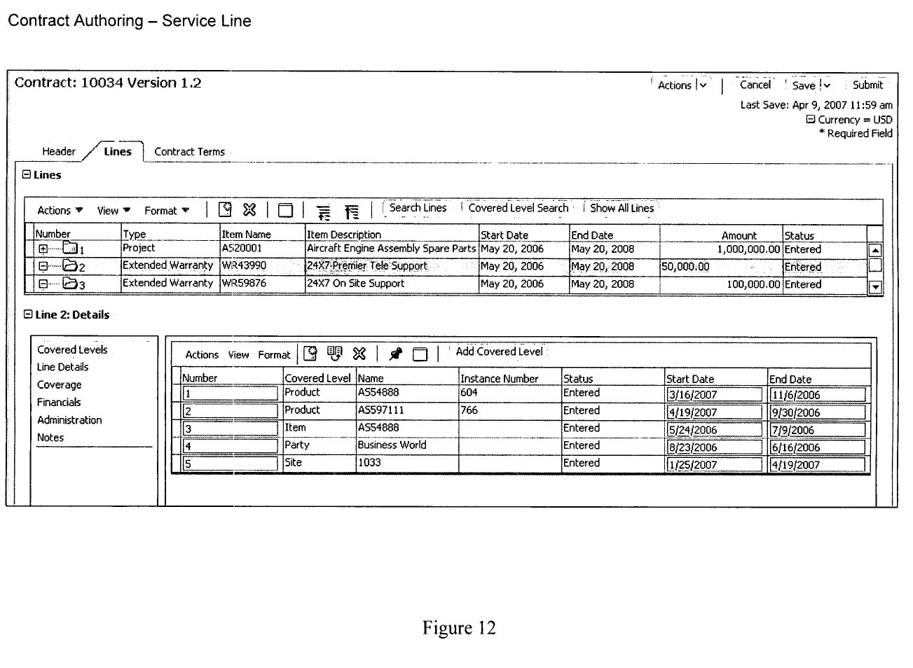

FIG. 12 shows a computer screen for a contract authorizing, service line, page of a unified electronic contract management system. This screen shows another contract with lines of multiple different types. A first line has a project type, and a second and a third line have extended warranty types. The system allows specifying a contract with various different types of contractual arrangements using a single application.

The contract architecture allows users to define contracts that support all the types of sales arrangements, such as (1) sale of goods, (2) sale of an extended warranty or support, (3) sale of simple service, (4) sale of complex service, (5) long-term sales agreement, (6) pricing agreements and (7) lease or rental, as well as any other type of customer contract.

Users can define different contract types. Each contract type will allow one or more line types. Each line type will support one of the types of arrangements discussed. So there is a line type for a complex service (a project), another line type for an extended warranty, and others.

In addition to defining what line types are allowed on a contract, the contract type will have attributes that identify other aspects of how the contract should operate. Users can define as many contract types as needed to identify the types of deals that they typically engage in. Different business units may have different contract types. For example, one business unit may handle only lease arrangements, and another business unit could handle product sales. Users will only have access to create contracts for the contract types that are relevant for their role in the organization.

When creating a contract, the user can select the contract type for the contract. This will determine what types of information need to be captured for the contract, including what types of contract lines can be defined. Attributes that are not needed for this type of contract will be hidden so that the interface is as streamlined as possible. For each contract line that the user enters, the user will enter a line type from the set of line types allowed for the contract. The line type will in turn drive what attributes the user can enter for the line.

For an example involving a networking company, the contract might include four lines: (1) quantity of 100 routers, (2) 2-year extended warranty, 7×24 coverage (7 days a week, 24 hours a day, 1 hour response time), (3) a time and material project to design the network configuration, and (4) 10 percent discount if additional routers are purchased in the next year.

The user will choose a contract type that allows these four line types (product, extended warranty, project, and product discount). The user would then be able to define the four different contract lines on a single contract.

For each contract line, the user is prompted to define the attributes relevant to that type of line. For the routers, the user enters quantity and price. For the extended warranty, the user enters the duration of the service and the type of coverage. For the design project, the user defines the type of project and billing method. For the discount, the user defines the products that are included, and the amount of the discount. These are just examples, since each line type could have a significant number of attributes that could be entered to fully describe that aspect of the deal.

Once the contract is entered in the application and signed by the customer, the contract needs to be executed on. The contract information will be available to execution systems such as shipping, project management, billing, and service applications. For example, a project would be created in a project management application to deliver the network design, and refer to the billing method defined on the contract. Any billing application could look at the contract data to bill for the routers and extended warranty. Service applications could check the customer's coverage on the contract when the customer calls in for support.

By supporting user configurable contract types, a single contract can support all aspects of the sales arrangement. This supports the way companies want to do business, instead of forcing them to modify their business processes to match what the applications can support. While this description has been specific to the sell side, it should be noted that the same concept can be applied to contracts on the buy side such as purchasing agreements.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

The invention claimed is:

1. A method comprising:
for interfacing to an enterprise contract management system, displaying a first computer user interface screen for a user to specify a contract type for a contract, wherein the enterprise contract management system handles a plurality of different contract types; and
after the user specifies the contract type, displaying a second computer user interface screen for the user to specify at least one contract line by selecting from a plurality of different contract lines for the contract.

2. The method of claim 1 comprising:
storing the contract in a database of the enterprise contract management system.

3. The method of claim 1 wherein through the second computer user interface screen, the user can specify one or more lines, where each line can have a different contract line type.

4. The method of claim 1 wherein in a portion of the second computer user interface screen, showing a details view of a selected contract line type.

5. The method of claim 1 wherein the plurality of different contract line types comprises at least one of an extended warranty type or project type.

6. The method of claim 1 wherein the second computer user interface screen comprises a plurality of lines, each for specifying a contract line.

7. The method of claim 6 wherein for each contract line, there is a type column, item name column, item description column, start date column, end date column, and status column.

8. The method of claim 1 wherein when the contract line specified for a project type, displaying in a details view portion of the second computer user interface screen a plurality of attributes including project, task, billing schedule and other information specific to a project type line.

9. The method of claim 1 wherein when the contract line specified for an extended warranty type, displaying in a details view portion of the second computer user interface screen a plurality of attributes to specify the coverage, covered products and other information specific to an extended warranty type line.

10. The method of claim 1 wherein in using a contract line type, the user can define contract lines that describe agreements related to future purchases.

11. A method comprising:
displaying an interface screen for defining a plurality of common attributes for a contract handled by the enterprise contract management system; and
displaying an interface screen for adding of a plurality of contract lines for each contract, wherein each contract line comprises a separate set of attributes of the contract trackable by the enterprise contract management system.

12. The method of claim 11 wherein the separate attribute is not a common attribute.

13. The method of claim 11 wherein the contract line is used to track tiered pricing based on a number of items purchased during a time period.

14. The method of claim 11 wherein the contract line comprises extended warranty terms for a plurality of different items, each item having potentially different extended warranty terms.

15. The method of claim 11 wherein the contract line comprises at least one of a sale of goods, a sale of an extended warranty or support, a sale of simple service, a sale of complex service, a long-term sales agreement, or a lease or rental.

16. A system comprising:
an enterprise contract management application component, wherein each contract may be specified using multiple contract lines, each contract line comprising a separate set of attributes of a contract trackable by the enterprise contract management system;
a database component, interfacing with the enterprise contract management application and storing contract data of the enterprise contract management application; and
a user interface component, interfacing with the enterprise contract management application and permitting a user to create a contract in the enterprise contract management system.

17. The system of claim 16 wherein the user interface component provides a first user interface screen for a user to define a plurality of common attributes for a contract handled by the enterprise contract management system.

18. The system of claim 17 wherein the user interface component provides a second user interface screen for the user to add and specify one or more contract lines for each contract.

19. The system of claim 18 wherein the second user interface screen provides a details view showing a detail for a selected contract line.
